(19) United States
(12) Patent Application Publication
(10) Pub. No.: US 2026/0354576 A1
(43) Pub. Date: Nov. 12, 2026

(54) STORAGE SYSTEM

(71) Applicant: YOKE CNC LTD, Borehamwood (GB)

(72) Inventors: Stefan Hewitt, Borehamwood (GB); Elliot Lunn, Borehamwood (GB)

(21) Appl. No.: 19/476,979

(22) PCT Filed: Apr. 19, 2024
(86) PCT No.: PCT/GB2024/051026

§ 371 Date: Oct. 20, 2025

(30) Foreign Application Priority Data
Apr. 20, 2023 (GB) 2305854.8

(51) Int. Cl. A47B 47/00

(52) U.S. Cl. CPC A47B 47/0075

(57) ABSTRACT

The invention relates to a storage system to allow simple and effective mounting of a storage element or module in a storage unit avoiding the need for complicated installation of fasteners and allowing installation once the storage unit shell is in situ. The invention uses an alignment mount positioned on an upright to correctly locate and support the mounting panel in position on the uprights.

### FIELD OF THE INVENTION

The invention relates to storage systems and in particular shelving or racking systems for installation in vehicles.

### BACKGROUND

Shelving and storage systems provide a convenient way for tradespeople to store tools and supplies in an accessible and organised way, especially those installed in vehicles to allow items to be carried to work sites. However, different trades and even different tradespeople have different requirements. In addition, different vehicles have different layouts, such as length, width, height, as well as position and configuration of wheel arches, doors etc. As a result, the number of permutations of requirements of tradespeople and vehicles means that it is difficult to provide a solution which is not bespoke to each installation. This is clearly undesirable for manufacturers and installers and makes the cost of the installation higher for the customer.

To try to avoid beginning from scratch for every installation, manufacturers have tended to try to produce racking systems which have a standard basic structure with some degree of adjustability to allow modifications to accommodate some variation in requirements. However, this tends to add to costs and also may undermine the space efficiency, function and strength of the finished installation.

Installations tend to have one or more sections or units, each having uprights supporting shelves or modules between them. These uprights may be shared between adjacent units or each unit may have its own uprights which can help to improve strength and ease construction. However, the thickness of every extra upright can add to the over length of the units which can waste space in a vehicle where space is already limited.

Construction is a balance between ease and efficiency of construction and material costs. Units tend to be constructed out of plywood boards such as birch ply or eucalyptus core ply, which provides a good balance between strength and cost, as well as ease of processing to manufacture the units. The plywood is generally supplied in large boards which are then machined to produce the elements used to construct the units. The elements are then put together and secured to form the parts of each unit. A number of different techniques are currently used to construct units.

Some systems utilise a simple arrangement of shelves arranged between upright supports where the shelves are secured to the uprights by inserting screws from the outer surface of the upright through the upright and into the end of the shelf. Two or more screws can be inserted from each end. This arrangement provides a relatively strong structure but means access must be available to the outsides of the uprights to be able to screw the screws in. This is generally done by constructing the units outside of the vehicle or final installation location and then moving the constructed units into position. This makes any subsequent adjustments difficult without uninstalling the units again.

Other systems use slots in the uprights to receive corresponding tongues on the ends of shelves; shelf-backs (vertical strips to provide a back for shelves to prevent items falling off the back of the shelf); or modules which may include one or more shelves, shelf backs or shelf sides (vertical portions arranged at the right and left hand ends of shelves). These tongues are inserted into the corresponding slots or recesses in the uprights to provide support for the weight of the shelves or modules and their contents. The shelves or modules are then typically screwed or bolted to the uprights to secure them in place and provide rigidity to the overall unit.

As before, the need to insert the tongues into the slots in the uprights, means the uprights can only be put in place once the shelves or shelf modules are already in place since inserting them once the uprights were already in position would otherwise not be possible. Whilst slots can be arranged at convenient spacings to allow variation in the initial design so that shelves can be placed at different vertical positions, the need to dismantle the uprights makes adjustments difficult once the units are constructed. Furthermore providing multiple slots in the uprights may undermine strength and also requires significant machining effort when they are produced. Because of the potential weakening of the structure, the number and spacing between slots is limited. Also, the bolts or screws for securing the shelves are typically inserted from the outside of the uprights which, as described above, makes construction in situ difficult.

Other systems may utilise modules which can be inserted between the uprights after they have been constructed making positioning easier. These modules are typically bolted in place by passing a bolt from the outside of the upright through the upright into the side of the module and then a nut is used on the inside of the module to secure them. By providing spaced holes in the uprights, the vertical position of the shelves can be varied according to desired layout. Loading the shelf and contents onto bolts does concentrate the load onto a small part of the plywood structure which can limit strength. These racking systems may be used to carry heavy items which when thrown about in the back of a moving vehicle can impose loads substantially higher than the static load of the items. The bolts tend to protrude from the outside of the uprights or into the space between the uprights potentially wasting some of the available width on each shelf or requiring the units to be wider to accommodate them. It also takes time and effort to undo/tighten bolts, and it can be a challenge to align the bolt holes of the modules with respective holes in the uprights.

These units are often designed to accommodate items such as tool boxes having specific widths, so are built to specific standards.

As will be apparent, with the various solutions mentioned above, some offer some advantages but often with some drawbacks. There is therefore a need to provide a racking solution which is easy to construct in situ, allows reconfiguration where requirements change, is strong enough to carry the loads experienced in these applications and which is not overly complex to manufacture and where manufacturing does not undermine the inherent strength of the structural components.

The present invention sets out to address or at least ameliorate at least some of the issues with the prior art.

### SUMMARY OF THE INVENTION

Therefore according to the present invention there is provided a mounting system for a mounting system for a storage unit, the storage unit having a pair of laterally spaced apart upright panels separated from each other by a first distance, each upright panel having a plurality of spaced apart holes, the mounting system comprising: first and second mounts, each having one or more protruding mounting elements, each mount being removably mountable on a respective one of said upright panels by inserting said one or more protruding mounting elements into respective holes in said upright panel, to support said mounts on the upright panel; and a storage module having a width substantially corresponding to the first distance, a mounting panel being provided at each side of the storage module such that the sides of the storage module are substantially adjacent to the respective upright panel when the storage module is placed between the upright panels, each mounting panel having: a supporting portion having a lower edge arranged to rest on and be supported by the mount when the storage module is placed between the upright panels; and a retaining element extending at least partially between the front and rear of the mounting panel and at least partially overlapping the inner lateral edge of the mount when the storage module is placed between the upright panels, such that the mount is retained between the upright panel and the retaining element to prevent lateral movement of the mount away from the upright panel.

With this arrangement, the uprights can be installed first to provide the shell of the storage unit and then the separate modules can be installed subsequently. By providing the mounts on which the mounting panel is supported once in place, no additional fasteners are required to retain the module in place. Furthermore, by virtue of the retaining member preventing the mount coming out of the panel, the mount also needs no further means to retain it in place, although additional fastening might be used. Nonetheless, the storage unit is essentially self-supporting once the storage unit is slid into place, making adding any additional optional fasteners unnecessary but easier to install if they are used.

The mounting element is preferably a securing pin projecting from the mount, which is insertable into a corresponding hole in said upright panel. This provides a simple arrangement that is easy to produce and very easy to install in the correct position.

The mount may include a plurality of pins spaced from each other at intervals corresponding to a plurality of holes provided in the upright panel such that the mount can be accurately positioned. By utilising two or more pins, the precise configuration of the mount can be controlled such that, mount is much easier to locate in the correct position and orientation. This can be achieved by two pins by having the spacing of the pins correspond to unique spacings of the holes provided in the uprights. Additional pins can help to further verify and simplify the locating of the mount.

The dimensions of the holes in the uprights are preferably sized to match the dimensions of the pin, so that the pins provide a snug fit when inserted into a hole. This helps to retain the mount in position when inserted into the uprights. However, ensuring accurate tolerances may be difficult and add to manufacturing costs. It may also restrict other aspects of the use of the holes such as receiving fasteners. It should therefore be appreciated that this is not essential and the pins may be smaller than the holes. Other means may be used to ensure the mounts are retained in place, both temporarily prior to the module being inserted and once the module is in place, as discussed herein.

The upright panels preferably include holes spaced at predefined intervals for receiving the pins with the pins spaced apart from each other by a distance equal to the spacing between corresponding holes in said upright to define at a defined orientation at which the mount can be installed. By selecting pairs of holes (where the mount has two pins) which may be at different orientations and so different spacings, the unique orientation is defined as the mount cannot be inserted at different orientations since the hole spacings will not correspond. The mount may include more than 2 pins which may match up to corresponding sets of holes in the upright.

Preferably, the mount includes a first portion having a first profile and the mounting panel has a recess having a second profile corresponding to at least a portion of said first profile, for receiving the first portion of the mount in said recess. This allows the matching profiles to be brought together so that the mount can be received into engagement with the mounting panel at a predefined position and alignment. The precise nature of the profile is not critical but they should ideally be arranged so that the first profile forms a snug fit with the second profile to restrict relative movement once engaged.

The first profile and second profile are preferably shaped such that the mounting panel can be lowered in a first direction, e.g. typically downwards onto the mount, such that the mounting panel and the mount engage with each other in an engaged position in which further movement is prevented due the engagement of the first profile and second profile. In this way, the module can be lowered onto the mount and then supported there in the engaged manner to allow the module to be retained without any additional support, allowing the installer to carry out other tasks such as picking up and installing additional fasteners or moving on to the next module.

The first profile may include an alignment feature to guide the mounting panel into the engaged position By providing such an alignment feature, any offset or misalignment of the module and mounting panel as it is lowered into position will tend to be corrected by guiding them towards the correct position.

The alignment feature can include a tongue-like projection having angled guiding sides. The tongue-like projection will preferably project generally towards the mounting panel and the corresponding profile so that as the tongue enters the corresponding recess any offset will cause the sides to engage and nudge the module towards the desired position. It will be appreciated that whilst the tongue-like features may be provided on the mount so that it projects toward a corresponding recess in the mounting panel, the tongue may be provided on the mounting panel and a corresponding recess provided on the mount.

The mount may be provided with one or more additional fastener holes for receiving a fastener to provide additional securing points of the mount on the upright panel. The mount is initially held in position by the pins inserted into the upright. Other temporary options may be used to aid retaining the mount in position during installation, such as adhesive pads on the interface between the mount and the upright. However, to ensure the mounts remain in position, holes may be provided to allow the mounts to be secured by fasteners once put in position. These fasteners may also act to provide additional support to the module in use, via the mount.

The mounting panel may similarly be provided with one or more fastener holes for receiving a fastener to provide additional securing points of the mounting panel on the upright panel. Such additional fasteners enhance the security of the module on the uprights which may be advantageous especially where large loads are supported or considerably movement and vibration experienced, such as in a moving vehicle.

The storage module generally includes one or more shelves supported by said mounting panel. Other module formats may be used such as hooks or hangers or slats etc. These all provide the utility of the module once installed in the unit. The module may be as simple as a rail with the mounting panel at each end to allow items to be hung on the rail or for example reels of wire to be placed on the rail. Alternatively, the mounts may have a different shape perhaps including a U-shaped recess on the upper surface allowing a rail to be dropped into the recess. The recess may not extend across the entire width of the mount, so that when the rail is dropped into place, its ends engage the portion of the U-shaped recess not removed, to prevent the mounts from being removed deliberately or accidentally from the uprights. The rail could also include a flange with a diameter larger than the width of the recess, the flange arranged just short of the end of the rail so that the stub end of the rail sits in the recess and the flange sits just adjacent to the outer face of the mount. This can serve in preventing the mount falling out of the holes or being removed. Other options than a rail may be used whilst supported on the mount.

The storage module may include a plurality of shelves supported by said mounting panel at predefined spacings. The shelves can be spaced independently of the spacing of the available mounting positions of the mount on the upright. In this way, each module can provide a set of shelves with layouts and configurations specific to that module and not constrained by the uprights. This allows retrofitting of different modules and layouts should requirements change, without needing to modify the uprights and the rest of the storage unit. It also means that the spacing of shelves can be configured to different applications such as standards of storage containers and also that these configurations are not constrained by the layout of the uprights and in particular the holes in them.

The mounting panel may include one or more slots for receiving respective tongues projecting from said one or more shelves to support said shelves in use. This allows the shelves to be supported on the mounting panels without the need to glue/screw or otherwise attach them together. This provides a simple construction method to form the modules. With the tongue inserted into slots in the mounting panels, the mounting panels held together, initially by hand, but subsequently by being contained between the uprights, the shelves remain engaged irrespective of any additional fasteners although some fasteners would normally be used to help to improve the rigidity and strength of the structure.

The present invention also provides a kit of parts for a mounting system for a storage unit having a pair of upright panels, each having a plurality of spaced apart holes, for receiving one or more storage modules therebetween, the kit comprising: one or more mounts, each having one or more protruding mounting elements, each mounting element insertable into one of said holes for locating the mount on one of said upright panels and to support said mount on the upright panel; and a storage module having a first width, in use, the storage module having a mounting panel provided at each side of the storage module such that the sides of the storage module are substantially adjacent to the respective upright panel when the storage module is placed between the upright panels spaced apart by a first distance substantially corresponding to said first width, each mounting panel having: a supporting portion having a lower edge which rests on and is supported by the mount when the storage module is placed between the upright panels; and a retaining element extending at least partially between the front and rear of the mounting panel and at least partially overlapping the inner lateral edge of the mount when the storage module is placed between the upright panels, such that the mount is retained between the upright panel and the retaining element to prevent lateral movement of the mount away from the upright panel.

The present invention further provides a method of mounting a storage module in a storage unit having: a pair of upright panels for receiving a storage module therebetween; a mount having one or more protruding mounting elements for supporting the mount on said upright panel; and a storage module having a first width and having a mounting panel at each end, each mounting panel having: a supporting portion having a lower edge; and a retaining element extending at least partially between the front and rear of the mounting, the method comprising: arranging the upright panels a first distance apart substantially corresponding to the first width; inserting the mounting pins of each mount into corresponding holes on each upright panel; positioning said storage module between said upright panels such that the sides of the storage module are substantially adjacent to the respective upright panel; lowering the storage module so that said lower edge rests on each mounting panel rests on and is supported by a respective mount and the retaining element at least partially overlaps the inner lateral edge of the respective mount to retain the mount between the upright panel and the retaining element, to prevent lateral movement of the mount away from the upright panel.

### DRAWINGS

Specific embodiments of the present invention will now be described with reference to the attached drawings in which:

FIG. 1 shows an example of storage unit constructed using the present invention;

FIG. 2 shows the frame of the unit shown in FIG. 1;

FIG. 3 shows the frame with module mounts in place;

FIG. 4a shows the frame with the mounting panels in place;

FIGS. 4b-4d show enlarged views of the engagement area of the respective mounting panel and mount;

FIG. 5 shows a more detailed view of the frame of FIG. 4a;

FIG. 6a shows a perspective view of a first mount;

FIG. 6b shows a top view of a first mount;

FIG. 6c shows a side view of a first mount;

FIG. 6d shows an end view of a first mount;

FIG. 6e shows a cross section of the first mount along line C-C;

FIG. 7a shows a perspective view of a second mount;

FIG. 7b shows a top view of a second mount;

FIG. 7c shows a side view of a second mount;

FIG. 7d shows a cross section of the second mount along line A-A;

FIG. 8a shows a perspective view of a third mount;

FIG. 8b shows a top view of a third mount;

FIG. 8c shows a side view of a third mount;

FIG. 8d shows an end view of a third mount;

FIG. 8e shows a cross section of the third mount along line D-D;

FIG. 9a shows a perspective view of a fourth mount;

FIG. 9b shows a top view of a fourth mount;

FIG. 9c shows a side view of a fourth mount;

FIG. 9d shows a cross section of the fourth mount along line B-B;

FIG. 10a shows a detailed view of the first mount and first mounting panel;

FIG. 10b shows a detailed view of the first mounting panel;

FIG. 11a shows a detailed view of the second mount and second mounting panel;

FIG. 11b shows a detailed view of the second mounting panel;

FIG. 12a shows a detailed view of the third mounting panel and a first mount;

FIG. 12b shows a detailed view of the third mounting panel;

FIGS. 13a and 13b show a perspective view of an alternative mounting panel;

FIG. 13c shows a perspective view of the alternative mounting panel and a second mount;

FIG. 14a shows a perspective view of a pin;

FIG. 14b shows a side view of the pin;

FIGS. 15a and 15b show alternative mounting panel arrangements;

FIG. 16 shows a further alternative mounting panel for accommodating more than one mount; FIG. 17 shows another alternative mount;

FIG. 18 shows a simplified mount;

FIG. 19 shows a modified mounting panel in position on the simplified mount;

FIG. 20 shows a further alternative mount;

FIG. 21 shows a mounting panel for accommodating two mounts; and

FIG. 22 shows a variant of the mounting panel above positioned at a different angle.

### DETAILED DESCRIPTION

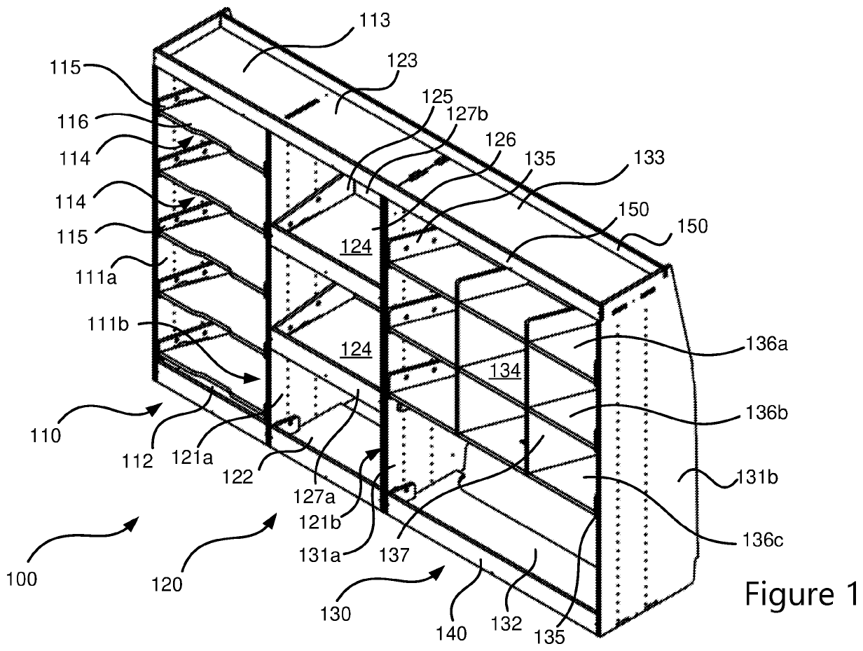

FIG. 1 shows a unit 100 constructed using elements of the present invention. The unit includes three separate sections 110, 120, 130 each with different shelving arrangements. These arrangements are merely provided as examples of different options that may be employed using the invention and the invention is not intended to be limited to these examples only.

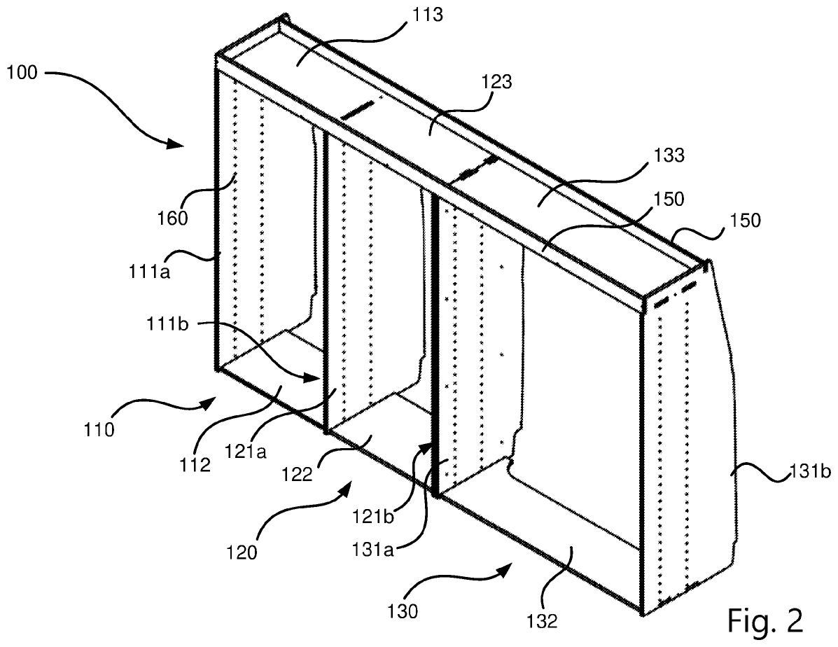

As shown in FIG. 2, a first section 110 includes vertical upright panels or uprights 111a, 111b at each side of the unit. The section has a base panel 112 between the lower parts of the uprights 111a, 111b and a top panel 113 arranged between the upper parts of the uprights.

Each of the other sections have a similar basic structure with corresponding uprights 121a, 121b, 131a, 131b; base panels 122, 132; and top panels 123,133, as shown in FIG. 1. Instead of separate base panels 112, 122, 132 and top panels 113, 123, 133 for each unit, a single base panel and top panel may form the respective base and top panels for some or all of the units. The uprights between adjacent sections are generally integrated as a single element. In other words, the upright 111b on the right hand side, as shown in FIG. 1, of section 110 is the same element as upright 121a on the left hand side of section 120. This uses a single component (i.e. a panel or panel from a board) the same as the other sheets 111 a, 121b/131a, 131 b. The integrated uprights 111b/121a, 121b/131a may however be constructed using a thicker sheet than the end uprights 111a, 131b or two abutted sheets. In a similar way, the top panels 113,123,133 and base panels 112,122,132 may be formed from a single component spanning two or more sections.

The arrangement shown in FIG. 1 shows additional elements such as the lower panels 140 at the foot of the sections and the upper panels 150 at the top. These may serve to reinforce the structure as well as other functional and aesthetic purposes but that is not particularly relevant to the invention.

Each section also includes one or more modules 114, 124, 134 arranged between the uprights and supported thereon. Section 110 includes five similar first modules 114 arranged in a spaced apart configuration to form a series of shelf units. In this case, the first modules 114 include shelves 116 angled so that they slope down towards the rear of the unit. The shelves 116 are supported between mounting panels 115 arranged at each end of the shelf. A rear generally upright panel (not shown) provides a back to the shelf.

Section 120 includes two second modules 124. These are different to the first modules 114 and form a tray-like structure with a shelf 126 forming the base of the module 124 with mounting panels 125 at each side, which the shelves are supported on. The modules 124 also include a front panel 127a and rear panel 127b to form the front and rear parts of the tray-like form of the module.

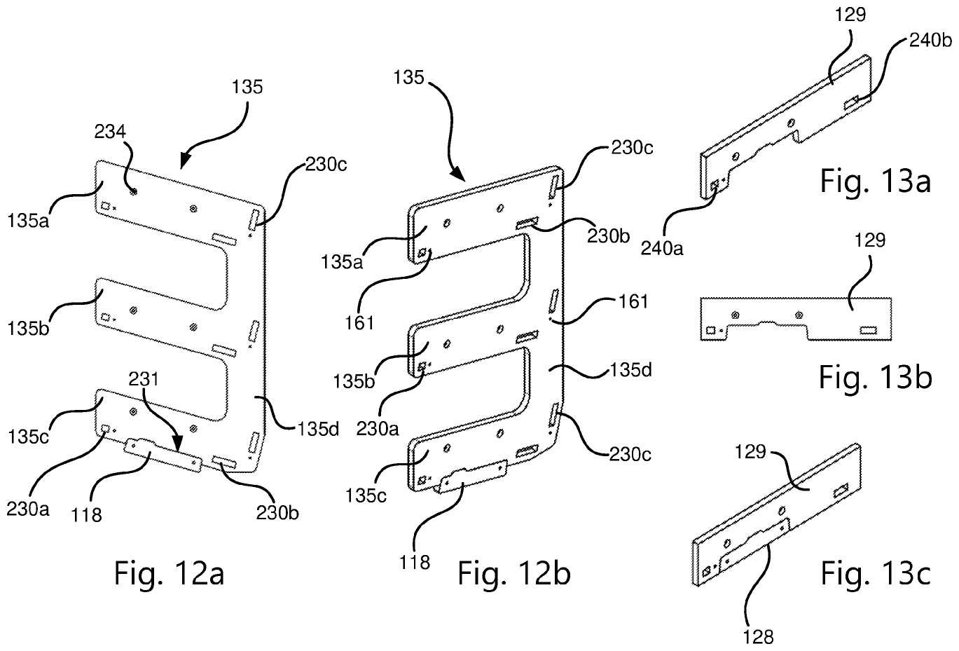

In the unit of FIG. 1, section 130 includes a single module 134. The module has two generally E-shaped mounting panels 135 arranged at each side of the module 134. The E-shaped panels 135 have three arms 135a-c connected by upright portion 135d (see FIGS. 12a and 12b). A shelf 136a is provided between respective pair of arms 135a, each on a respective mounting panel 135. Similar shelves 136b, 136c are provided between the other pairs of arms 135b and 135c. Additional dividers 137 may be provided, as shown in FIG. 1, to partition the space on the shelves into sub-spaces. As well as sub-dividing the space, these dividers can also provide additional structural support to the shelves, especially where they span a longer distance.

In the arrangement of FIG. 1, two dividers 137 per shelf are shown. With this arrangement, the single module 134 provides 9 separate sub-spaces whilst allowing the entire module to be installed as a single item between the end panels 131a and 131b. Whilst only a single module 134 is shown in FIG. 1, more than one may be provided. Also, different configurations of modules with different numbers of shelves 136a-c and dividers 137 may be provided.

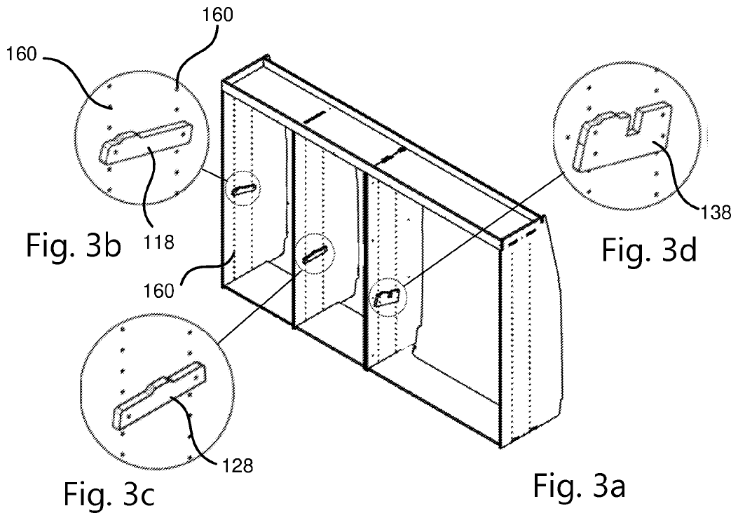

The modules and the elements that form them will now be described in more detail below. Each of the modules 114, 124, 134 is arranged to have a width corresponding to the gap between the corresponding left uprights 111a, 121a, 131a and right uprights 111b, 121b, 131b. Each module is inserted into the gap and then lowered on to corresponding mounts mounted on the uprights. FIG. 3a shows the empty unit awaiting installation of the desired modules. Pairs of mounts, described in detail below, are mounted to the respective uprights.

FIG. 3b shows an enlarged view of a mount 118 mounted onto the left upright 111a in FIG. 3a. A corresponding mount 118 (not visible) is mounted on the upright 111 b. Similarly, FIG. 3c shows an enlarged view of a mount 128 mounted onto the left upright 121a in FIG. 3a. FIG. 3d shows an enlarged view of a mount 138 mounted onto the left upright 131a in FIG. 3a.

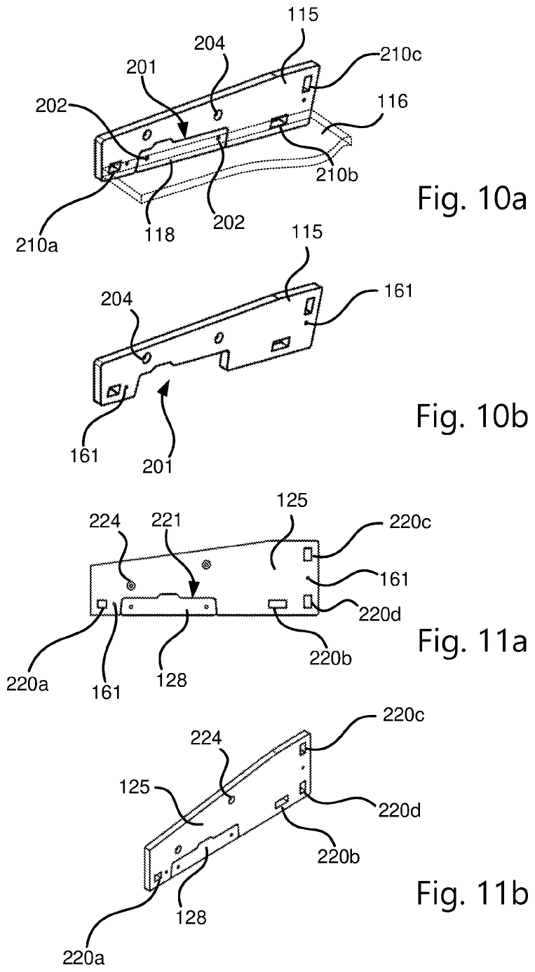

As described above, the first modules 114 are constructed from a shelf 116 which is a generally rectangular sheet, although it may include features (such as the front indent shown in FIG. 1) for aesthetic and functional purposes. The shelf includes two pairs of projections or tongues (not shown) extending from the left and right hand ends of the shelf. The tongues are received into corresponding slots 210a, 210b in the mounting panels 115. These can be seen in FIGS. 10a and 10b. The tongues provide support for the shelf once the module is installed in the unit and prevent movement of the shelf forward and backwards or up or down.

Although not shown in FIG. 1, the first module 114 may include a rear panel, similar to the rear panel 127b which acts as a retainer. This panel is again formed of a generally rectangular sheet which extends between the mounting panels 115 once installed. The rear panel also has a tongue projecting from each end with each tongue being received in a corresponding slot 210c (see FIGS. 10a and 10b). Once installed, the rear panel is retained by the tongues preventing movement of the rear panel. Additional slots, similar to slot 210c may be provided similar to slot 220d shown in FIG. 11a, may also be provided to provide additional support to the rear panel. The rear panel may also be keyed into the shelf 116 in a similar way by having additional respective tongues and slots to engage each other. For example, the rear panel may have one or more slots for receiving a respective tongue projecting rearwardly from the shelf. Alternatively, the rear panel may have one or more tongues projecting downwardly and received into slots (which may be open on the rear side) in the shelf. A similar arrangement may be used where front retaining panels are used.

With this arrangement, the shelf, rear panel and the left and right mounting panels can be fitted together without needing any fastenings, although some fasteners are typically used to simplify installation. Even so, having the tongue and slots makes the assembly of the modules much simpler meaning the skills required to construct them is dramatically reduced. The slots and tongues may be formed with tight tolerances to provide a relatively tight fit to initially hold the parts in engagement with each other but this is not essential, as the parts will be retained once inserted into the unit 100 between the uprights, as described below.

As shown in FIG. 10b, the mounting panel 115 is provided with a cut-out or recess 201 on its lower edge. The recess 201 has a profile corresponding to that of the mount 118, as shown in FIG. 10a. In this way, the mounting panel 115 can be engaged with the mount 118 to provide a snug fit.

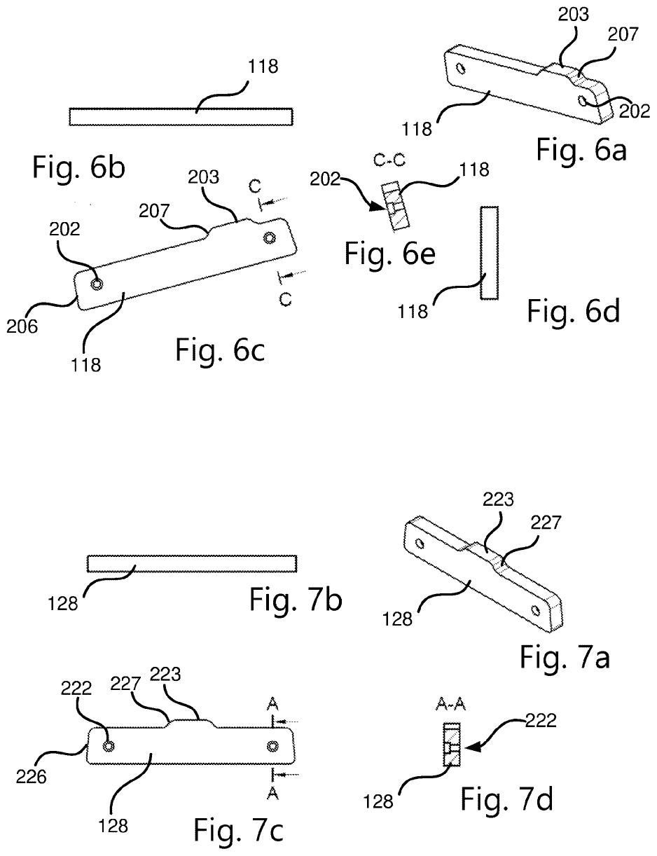

The mount 118 is shown in more detail in FIGS. 6a-6e. The mount acts as an alignment tool for accurately positioning the modules. As can be seen in the perspective view of FIG. 6a and also FIG. 6c, the mount 118 includes a profiled upper surface. In this example, it consists of an alignment tongue 203 projecting from the upper surface of the mount 118. The profile of the alignment tongue 203 is shaped to match a corresponding portion of the inner profile of the recess 201. The tongue 203 is provided with a rounded outer profile with angled edges 207 rather than sharp right angled edges. This helps to guide the mounting panel 115 into position on the mount 118 more easily.

In FIGS. 6a-6e the mount has a uniform planar cross section but it may be provided with a varying profile across the thickness of the mount. For example, the mount 118 may include a central ridge to engage (like a tongue and groove arrangement) with a corresponding central groove recessed into the top of the recess 201. Once the ridge was received into the groove, it would engage with the mounting panel, to prevent lateral movement of the mount relative to the mounting panel, i.e. in a direction away from the upright and in which the pins 205 would come out of the holes 160 in the upright. This would prevent movement of the mount out of its mounted position on the upright.

The mount 118 may also include gently tapered end portions 206 as shown in FIG. 6c. Similarly, the recess 201 would have tapered inner sides. In this way, the slightly narrower upper dimensions of the mount 118 can slip easily into the recess 201. As the mounting panel 115 is lowered onto the mount 118, the corresponding angled sides of the recess 201 and the angled sides of the mount 118 will engage, guiding the mounting panel into place on the mount 118.

As noted, the angled edge 207 of the tongue and the tapered edges 206 help to aid insertion. If the edges were all simple right angles, there is a likelihood of the edge of the mount 118 engaging the lower edge of the mounting panel 115 either side of the recess. This would then require the jiggling of the module to get it into the correct position so that the mount is perfectly positioned between the edges of the recess. Instead, by providing the tapered edges 206 on the mount and corresponding tapers in the recess 201 of the mounting panel, the top of the mount is narrower than the entrance to the recess making it much easier to align. Furthermore, the same applies where the tongue is aligning with the corresponding recessed profile in the mounting panel. By providing the angled sides, any misalignment will tend to direct the mount and module into the correct position as the angled edges engage. Eventually as the mounting panel approaches its final position, it will be guided towards the correct position.

In order to install each module, a pair of mounts 118 is arranged at each side of the section. FIG. 3a shows mounts 118, 128, 138 arranged on corresponding left uprights 111a, 121a, 131a. Similar mounts are mounted on the right uprights 111b, 121b, 131b, although not visible in FIG. 3a. In these embodiments the mounts on each side are the same but could be different, for example with one mount as shown in the Figures to provide the alignment function and a different or simpler mount on the other side.

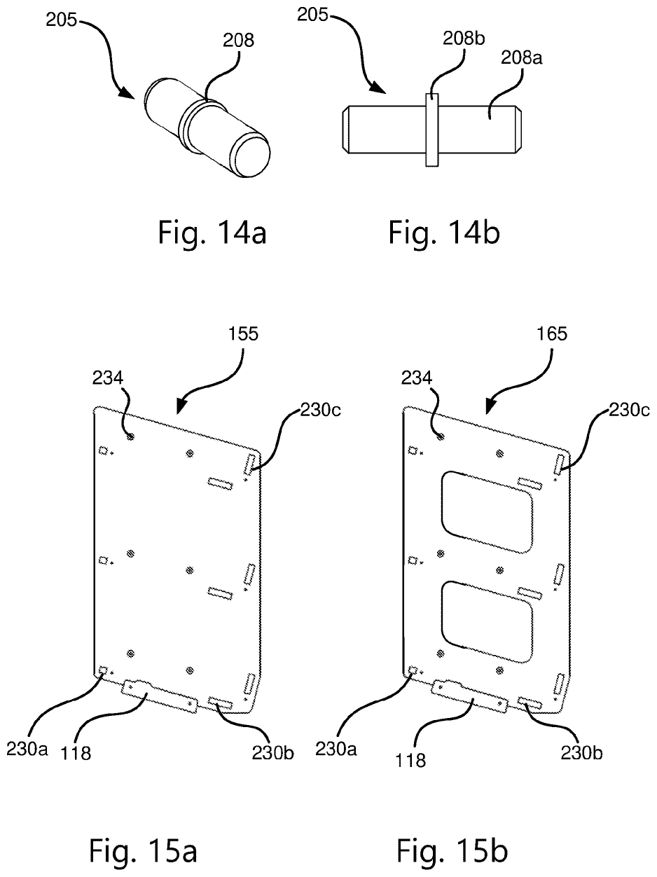

In order to secure the mounts, each upright is provided with a number of holes 160. In the unit 100, these are arranged in two vertical columns of holes 160. This allows the mounts to be selectively positioned at different heights according to the desired arrangement and to allow different configurations. The mounts 118, 128, 138 are also provided with holes 202, 222, 232 for receiving pins 205. In FIGS. 6a and 6c, the holes 202 are shown. FIG. 6e shows the cross-section of the mount 118 where the hole 202 can be seen. The holes are shaped to receive a furniture pin 205, shown in detail in FIGS. 14a and 14b. The pins have a generally cylindrical main body 208a with a central flange 208b. The hole 202 has two parts, with one part having a larger diameter than the other. The pin 205 is inserted into the hole 202 until the flange 208b rests in the enlarged diameter section of the hole 202 and one part of the main body 208a lies in the narrow narrower diameter section with the other part of the main body 208a protruding from the surface of the mount 118. The pin may be glued in place or simply held in place by friction.

The pins described above are preferably made of metal but may be made of other materials such as plastic or wood and the flange may be dispensed with.

The pins described above provide a simple method of securing the mounts on the uprights prior to installation. With accurately sized and matched holes, the pins will hold the mounts in place during installation of the modules. However, the invention may dispense with the pins and instead the mounts may be supported on the uprights by screwing them to the uprights. If the holes 202 are provided as before and spaced according to the desired orientation of the mount, as described above, the pins may be dispensed with by simply aligning the holes 202 with the respective holes 160 in the upright and then passing a screw through hole 202 and attaching to the upright in hole 160, to secure the mounts in position.

Once the pins 205 are inserted into the mount, the mount can be positioned on the corresponding upright. The holes on the mount 118 are spaced apart at a distance corresponding to the holes 160 on the upright. Depending on the desired orientation of the mounts on the upright, the spacing is selected so that the mounts can only be installed at the correct orientation. For example, the pins 205 on mount 118 are arranged to locate in holes 160 which are not horizontally aligned with each other but instead, the pin closest to the front of the unit is inserted into a hole 160 which is higher up the upright 111a than the hole into which the rearmost pin on the mount is inserted. This provides the mount 118 with an angled arrangement once installed.

Different variants of the mount may be used where the spacing of the holes 202 corresponds to different vertical offsets of the holes in the upright to provide more or less angled arrangements of the mount. For example, if the holes 160 are vertically separated by 34 mm from each other and each column of holes 160 are offset by 150 mm, the holes on the mount are 153.8 mm (√(150²+34²)) apart to allow it to be fitted between a pair of holes that are vertically offset. If the mount needs to be horizontal, then the holes 202 and hence pins 205 will be arranged 150 mm apart and if the mount is to be arranged at a steeper angle (e.g. with the front pin inserted into a hole two holes vertically above the rear hole then the holes 202 need to be spaced 163.1 mm (√(150²+64²)) apart. The holes may also be arranged to provide specific convenient angles. For example, where the vertical separation of the holes 160 is 34.0 mm, the horizontal separation could be 126.9 mm which ensures that the angle between one hole and the hole one above and one across is at a 15 degrees orientation.

The size of the holes and diameter of the pins do not necessarily need to match. This may be convenient where the hole sizes may be dictated by other constraints such as where additional fasteners are used and a different diameter may be preferable. The pins' size can then be freely selected for example based on readily available options on the market without containing the hole size. The mount could then be temporarily held in place by an adhesive pad or some other fastening means.

Whilst the precise layout of the holes 160 in the upright may be varied, by suitable combinations of hole spacings in the upright 111a and mounts 118 having different spacings, different orientations can be provided with only a small modification of the mount 118.

The mount 118 shown in FIG. 6e has the larger diameter portions of the hole 202 on one side and so (due to the asymmetric location of the tongue 203) a mirror image but not identical pair of mounts 118 will be used for mounting on respective uprights 111a and 111b. Alternatively, the larger diameter portion in the hole 202 may be duplicated at both ends of the hole so that the pin 205 can be received from either side. Different pins could be used which have no flange portion (not shown). The tongue could be arranged centrally, similar to the mount 128 in FIGS. 7a-7d, however, having an offset tongue has advantages as discussed below.

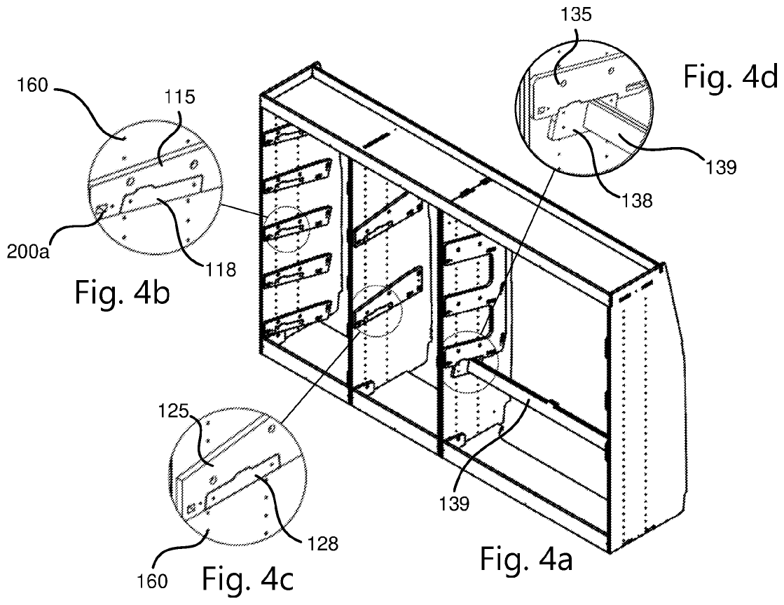

Once assembled, the mounts 118 can be arranged on the uprights 111a, 111b at the desired position by inserting the protruding ends of the pins 205 into respective holes. Once the mounts are in the desired position, the pre-assembled module described above can be brought into position by sliding it between the uprights above the mounts and lowered so that each mount 118 is received in the respective recess 201. Once the module is fully lowered into position, the matching profiles of the mount 118 and recess 201 ensure that the mount and the mounting panels are closely engaged with each other such that there is little movement of the module once in place. FIG. 4a shows the arrangement of the mounting panel 115 on the mount 118 with the rest of the module not shown. FIG. 1 shows the complete modules in position.

By using the mounts with the pins inserted, the mounting panels are guided to a precise location and supported by the width of the mount across the surface of the matching profiles. This is much better than simply mounting the mounting panel on pins alone as the load is particularly concentrated and if there is any possible sideways movement in the modules either when being installed or in use, that can mean that the modules rest on the ends of the pin rather than the entire length, putting considerable twisting force on them and potentially snapping them out of their holes. The mounts can provide a much wider base on which the mounting panel sits spreading the load out and also allowing more flexibility if the modules width and the spacing between the uprights is not exactly matched (either statically or in use). Simply resting the mounting panels on pins alone also means that there is no resistance to forwards/backwards movement unless the pins are received in recesses in the mounting panel, which requires additional machining of the mounting panels which is complicated especially if the recesses only extend partially through the thickness of the mounting panel.

The shelf 116 is held in position between the front shelf slot 210a and rear shelf slot 210b. As will be apparent from FIG. 1, the end of shelf bridges between them, across the recess 201. As a result once the module is lowered into position on the mount, the mount 118 is prevented from moving out of its position inserted in the upright and so is prevented from being removed or falling out. FIG. 10a shows the position of the shelf 116 in dotted lines. It can be seen from this how the shelf passes across the recess 201 to retain the mount within the recess. In this way, the entire module can be constructed and retained in its finished position without the need for any fasteners, although additional fasteners may be used in different places to provide additional strength and support to the structure. Various holes 161 are shown where additional fasteners can be used to secure the parts of the module more firmly together.

The first module 114 also includes a rear panel (not shown) similar to the rear panel 127b shown in FIG. 1. The rear panel includes a projecting portion or tongue at each end which is inserted into a corresponding slot 210c. As noted above an additional slot and corresponding tongue may be provided if additional strength is desired. Fasteners may be screwed from the outside of the module through hole 161 into the rear panel to increase strength. In this embodiment, the rear panel extends down behind the back of the shelf 116. Alternatively, the shelf 116 may extend under the rear panel. In either case, additional fasteners may pass through the shelf or rear panel and into the other to provide additional mutual support and overall strength of the module.

Whilst the general structure of the shelf and unit are maintained without fasteners, the module can still be lifted back off the mounts 118 manually or possibly during movement of the vehicle it is mounted in. It is clearly undesirable for the modules to become detached from the unit in use, so additional fasteners are preferable. In the mounting panel 115 shown in FIGS. 10a and 10b, additional holes 204 are provided. The holes pass through the mounting panel and may be countersunk to receive the head of a securing screw (not shown). The holes 204 are aligned with the holes 202 in the mount 118 and the layout of the four holes 202, 204 correspond to the layout of the holes 160 in the uprights. In this way, once the module is in position, the holes 204 will automatically line up with corresponding holes 160 allowing a securing fastener such as a machine screw to be inserted, to prevent movement of the mounting panel 115 and therefore the entire module.

Countersunk machine screws are preferably used (although other options may be used) which can be screwed into place from the inside of the module avoiding the need for access to the outer part of the uprights. This is more convenient than other options such as nuts and bolts where access is required from both sides and will reduce the available width.

The first module 114 described above, works in essentially the same way as the second module 124. The mount 128 shown in FIGS. 7a-7d is similar in many respects although the tongue 223 is arranged in a different location on the mount 128. On mount 128, the tongue is positioned more centrally but has a generally similar shape with the angled side edge 227. The mount also includes a similar tapered end portion 226 for easing installation of the second module 124. The position of the tongue can be used to help visually distinguish the mounts from each other. The position, i.e. central or offset, can be used to differentiate between mounts providing an angled installation arrangement compared to a horizontal one and so on.

The mounting panel 125 for the second module 124 does however, have a number of differences compared to the mounting panel 115. The first module 114 is arranged to be tipped backwards so that items placed on the shelf tend to be pushed towards the back and helps keep goods in place during transit. The second module 124 is installed to provide a generally horizontal shelf. To achieve this, the mount 128 is configured with the holes 222 spaced to correspond to the horizontal spacing of the holes 160, so that the mount 128 can be installed horizontally. This is in contrast to the mount 118 of the first module, which has holes 202 spaced to correspond to the distance between a front hole 160 and a rear hole vertically below it (as described above).

The recess 221 is similarly modified to have a shape corresponding to the mount 128 with the tongue 223 centrally located.

In this module, the rear panel 127b has pairs of protruding tongue portions (not shown) which are inserted into the respective upper rear slot 220c and lower rear slot 220d in each mounting panel 125 respectively. The shelf 126 has pairs of protruding tongue portions (not shown) which are inserted into the respective front slots 220a and rear slots 220b in each mounting panel 125 respectively.

The holes 224 are similarly arranged to align with holes 160 in the uprights 121a, 121b. As can be seen the holes 224 are arranged to align with holes 160 which are horizontally offset but not vertically offset, although they could be positioned differently to align with different holes 160.

The front panel 127a shown in FIG. 1 is attached to the left and right mounting panels 125 and the shelf 126 using fasteners such as screws or nails. However, an arrangement of slots and tongues could be used, similar to the rear panel.

The third module 134 has a slightly more complex structure but is similar in many ways to the first and second modules. The mounting panel 135 has an “E” shape consisting of three arms 135a-c connected by an upright portion 135d. The lower arm 135c is similar to the first and second modules' mounting panels and includes slots 230a and 230b for receiving the respective tongues of a shelf 136c. It also includes a recess 231 shaped and configured for receiving a mount. In the arrangement shown in FIGS. 12a and 12b, the mount 118 is the same as that shown in relation to the first module. This allows the same mount to be used for different modules reducing the number of parts needed for the different modules. However, different mounts may be used.

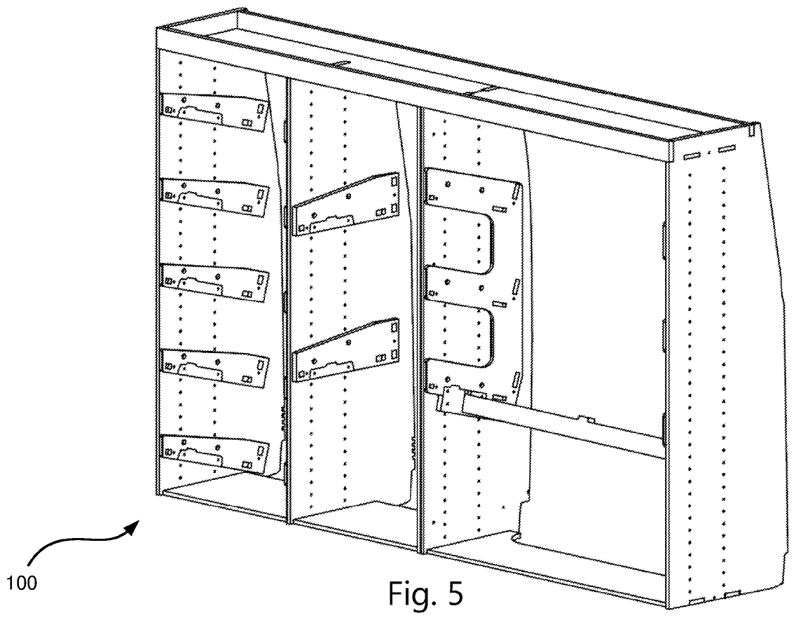

As shown in FIGS. 3a, 4, 5, 8a and 8b, a slightly taller mount 138 is used. This is similar to the mount 128 shown in FIGS. 6a-6e but is deeper and includes an additional slot 238. The tongue 233 and angled sides 237 are similar to the corresponding tongue 203 and angled side 207. The additional height of the mount 138 means the tapered edge 236 is also taller but functionally similar to taper 206. The mount 138 includes additional holes 239 which can be used to insert additional fasteners to supplement the pins used in the holes 232. The increased size of mount 138 allows for greater load bearing capacity for the shelves as well as increasing the overall structural strength of the unit. These are aligned with the holes 160 in a similar way to the additional holes 204, 224, 234 in the mounting panels.

The additional slot or notch 238 is provided to allow a cross member 139, shown in FIGS. 4a and 4d, to be slotted in. The mounts 138 are put in position as described above but prior to inserting the module in position, the cross member 139 is dropped into the space defined by the slots on the respective mounts 138 and the uprights 131a, 131b. This cross member 139 provides additional support for the shelf above and the entire module, via the dividers.

Using the larger mount 138 and the cross member 139, the additional load from the module having three shelves can be shared more evenly from the module to the mounts via the cross member and into the uprights via the additional fasteners inserted into the holes 239 as well as the pins inserted into the holes 232.

By using the mount 118, the orientation when it is installed on the upright will conform to that used on the first module and the shape of the mounting panel 135 is arranged to align it correctly. In this case, the arms 135a-c are swept slightly upwards as shown in FIG. 12a, so by mounting on the mount 118 which is also angled upward, the upright part 135d of the mounting panel is generally vertical.

It will be appreciated that different mounts may be used and the shape of the mounting panel adjusted accordingly to achieve the desired orientation and position of the module and the shelves within it. The shelves 136a, 136b, 136c have similar tongues (not shown) to those described above. In this example, the slot 230b is slightly wider than the slots shown previously. This may allow for greater strength when required. However, the slots may be similar in size to those in the first and second modules and the shelves may in fact be identical to reduce the variation in components and therefore the total component count needed to assemble the various modules.

The third module 135 is put together in a similar way with the tongues on the three shelves 136a-c inserted into the corresponding slots 203a, 230b. The rear panels (not shown) are added by inserting tongues on them into the respective slots 230c. The additional dividers 137 are secured in place. Alternatively, the shelves and dividers may be assembled first and then connected to the mounting panels. The complete module is then inserted between the uprights 131a, 131b and lowered so that the mounts 118 are received into the recesses 231 to locate the module in the correct position and orientation. The additional securing fasteners can then be inserted through the holes 234, aligned with respective holes 160 in the uprights.

The mounting panels 135 allow the structure of the third module 134 to be defined. This can be desirable where the user intends to use standard sized items on the units. For example tradesmen often obtain tools in standard sized containers, for example “Euro containers”. These have standardised dimensions and these can be reflected in the modules so that with the arrangement shown in FIG. 1, nine standard Euro containers can be reliably stored. This avoids having to provide three separate first modules 115 which would require manufacturing and installation separately. It also means that although the holes 160 may be laid out with a specific spacing, they do not need to be conformed so that multiples of the spacings correspond to the size euro container, or any other standard sized item to be stored.

For example, if a standard sized item to be stored is 260 mm tall and rests on a shelf of thickness 18 mm, the spacing between shelves would need to be 278 mm (including the box and the thickness of the shelf on which it rests) but if the spacing of the holes 160 is 34 mm, then the using the first modules would mean that the modules would have to be spaced at intervals of 306 mm, equivalent to 9 holes spacings. This would waste 28 mm of space for each shelf, which may not seem significant but over several shelves may mean an entire shelf is lost due to insufficient space. An alternative is to modify the spacing of the holes 160 to match the dimensions of the desired container or have a greater number of holes to minimise wasted space. However, the former requires modifying the uprights according to demand, denying the benefit of standardised uprights and the associated manufacturing benefits. The latter increases manufacturing cost and, if the spacing is small, can undermine the strength of the units.

Whilst Euro containers are one standard, there are other standards such as those used by specific tool manufacturers. This means that greater flexibility is needed. This can be achieved without compromising the standardisation of the uprights. For example, different modules, like the third module 134, can be used for differing standards. This only requires modification of the mounting panels 135 whilst maintaining the same uprights and mounts 118, 128, 138.

With the third modules, they can be configured so that the arms 135a-c are spaced at the desired 300 mm spacing irrespective of the spacing of the holes 160. It also means that different modules can be used for different standardised containers without having to modify the spacing of the holes 160. This gives greater flexibility in the utility of the design with standard uprights. It also means that the spacing of the holes 160 can be higher and consequently the total number lower, reducing manufacturing costs without compromising the efficiency of space utilisation which might suggest a smaller spacing between holes.

One further advantage of constructing the third module 134 with multiple shelves 136a, 136b, 136c rather than three separate levels or modules is that it can be used with wider spans, as shown in FIG. 1. If it were constructed as three separate levels, each level would potentially require its own additional cross supports 139, leading to a lot of wasted height on each shelf. With the arrangement of module 134, a single cross support 139 can be used at the bottom of the module avoiding the need for cross supports on the upper shelves. The dividers 137 can be used to help distribute the shelf loading down to the bottom shelf and to the cross support 139.

In the third module described above, with mounting panels 135 as shown in FIGS. 12a and 12b, the modules have the E-shape described above. However, it will be appreciated that this is just an example and modules having a simpler structure with only two arms separated by an upright portion could be used to provide a module with two shelves and equally a mounting panel with four or more arms may be used.

The E-shape configuration described above provides a convenient arrangement which minimises the use of material for the mounting panel and by using the E-shape allows the mounting panels to be cut from the same sheet by tessellating the “E”s together. However, this shape is not essential and the E-shaped mounting panel may instead be a different shape such as a more rectangular (or parallelogram) shape, i.e. by filling in the space between the arms of the “E”. For example, see mounting panel 155 in FIG. 15a. This might be useful to provide increased strength and rigidity, even if it is at the expense of greater use of material and less efficient cutting of the panels from a larger board. Other options such as mounting panel 165 in FIG. 15b might also be used.

These modified arrangements still provide the benefit of having multiple shelves mounted within a single module, allowing the spacing of the shelf to be determined by the mounting panels 155, 165 rather than being restricted by the hole spacing of holes 160.

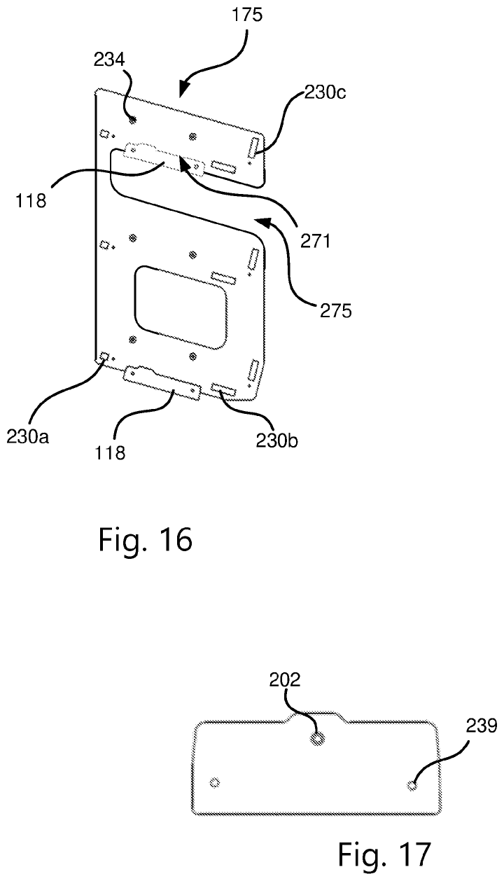

In a further modification, the mounting panel 175 shown in FIG. 16 has a different configuration with a “6”-shape and having an open side at the rear. This arrangement may also include an additional recess 271 provided for receiving an additional mount 118. With this mounting panel 175, the module can be installed in a similar way by inserting it between the uprights such that lower mount 118 is below the mounting panel 175 as the module is slid in and the upper mount 188 passes through the space 275 until the mounting panel 175 is above the mounts 118 and can then be lowered into position. This arrangement can be useful to provide additional support to the module and provide additional guidance as the module is being lowered into position.

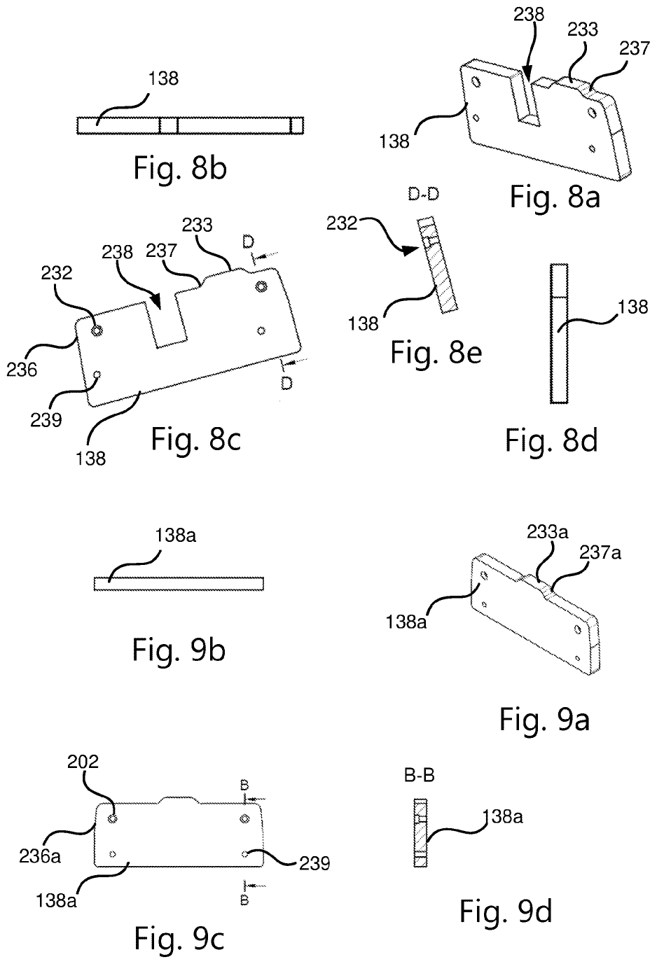

FIGS. 9a-9d show a further design of mount 138a. This mount is similar to the mount shown in FIGS. 8a-8e, with tapered edges 236a but a taller body and additional holes 239. It also includes a centrally located tongue 233a with a tapered edge 237a, similar to that of mount 128. This mount provides additional load bearing capacity by providing additional fasteners and also spreads the point of application of the load into the uprights.

It will be appreciated that the mount 118 and the mount 138 are designed to provide a support for angled shelves whilst the mount 128 and mount 138a are designed for use with substantially horizontal shelves. Other configurations may be used to provide alternative configurations and angles. Similarly, different mounting panels may be used for different requirements. This allows modification of the utility of the shelving unit but without modifying the basic upright which can be uniform for all arrangements. Only the mounts and mounting panels need to be adjusted to be specific to certain applications. Even then, as described above, the same mount may be used with different mounting panels and vice versa to maximise the utility of a small number of components.

FIGS. 13a-c show an alternative mounting panel 129 design, used, in this case with the mount 128. This design is similar to those above with slots 240a, 240b but has a substantially horizontal installation angle for horizontal shelves. It also has no slots for a rear panel as these are not required for the application anticipated.

It will be appreciated that the shape of the mounting panels may be varied for other purposes. For example, the mounting panel 115 and mounting panel 125 have an angled portion on the upper edge whereas the mounting panel 129 and mounting panel 135 have a flat upper portion, designed to suit their application and also to align with and support the rear panel, where used.

As noted above, the mounting panels 115, 125, 129, 135 are used in matching pairs like the mounts. The mounting panels of each pair are therefore not identical. To reduce component count, symmetrical mounting panels could be used by having the slots pass completely through the mounting panels. The holes 204, 224, 234 can also be symmetrical. These may be profiled to receive a screw head and so a suitable chamfer can be provided on both sides to ensure they are not required to work in a specific orientation. Alternatively no chamfer can be provided or the chamfer may be formed once in place.

The location of the tongues on the mounts 118, 128, 138, 138a are either central or offset on the upper surface. The precise location and shape of the tongues is not essential and they could all be modified in a number of ways. The location of the tongues allows different mounts to be differentiated by installers. For example, in the examples described above, the mounts with an offset tongue signify use on mounting panels for angled shelves whereas mounting panels with central tongues are for use on mounting panels for horizontal shelves. There is no particular structural significance to the position but it does provide a convenient visual differentiator in use. All the mounts could have the tongue provided in the same position. Additionally by having the tongue arranged centrally, the mounts are symmetrical and so the same identical mount can be used on either side of the module, avoiding the need to have matching mirror-image pairs or mounts which can accommodate the pins in either side.

The off-set tongue also allows for the slot for the extra cross supports shown in mount 138. This allows the slot to be more central whilst still providing utility of the tongue. Even so, the tongue could still be centrally located with the slot passing through the middle of it.

Similarly, the precise shape of the tongues is not fixed and the function of guiding the mounting panel into place on the mount can be achieved with other shapes. For example, the curved plateau shape of the tongues 203, 223, 233, 233a described above, could be replaced with a triangular profile which would similarly help to guide the parts into position.

The tapered edges are similarly modifiable to provide the guiding function of helping the mounting panel into the correct position. The taper could be greater or could even be dispensed with completely, although this makes alignment less convenient.

The mounts may have additional features such as the U-shaped recess referred to above to allow alternative modules or simple rails to be mounted onto the mounts. A mount may therefore serve both functions by having the profiled surface to engage with the mounting panels but also have a U-shaped recess for use with rails, or other simpler mounting panels.

In the examples above, the mounts are exemplified as having two pins. They may have more than two pins but may also have a single pin. FIG. 17 shows a simplified version of the mount of FIG. 9, where the two pin holes 202 are replaced by a single pin hole 202. This does not fix the mount in the exact orientation but will still limit the range of positions available to the mounting panel when installed and it can be fixed using additional fasteners, e.g. in holes 239. The pin hole 202 is shown located above the centre of gravity of the mount (although this is not essential) so that when installed, the mount can hang below the pin in a defined position and orientation.

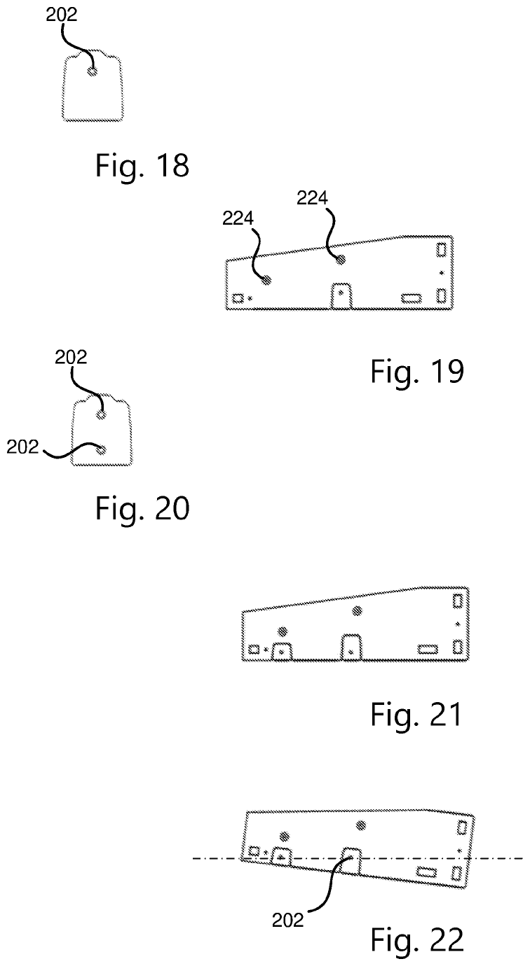

FIG. 18 shows a further modified mount with a simple single pin and no additional securing fastener holes. This would still allow the mounting panel to be located in position, as shown in FIG. 19.

The additional fasteners in the mounting panel allow it to be oriented in the correct position. The mount is still able to provide support and locating of the storage module as it is installed. It can also aid in supporting the load on the module in use.

FIG. 20 shows a further modified mount with two pins and no additional securing fastener holes but with holes in a different configuration. This would allow the mounting panel to be located in a fixed position as well as orientation, similar to the previous examples above. The profile, including tapered edges etc. can be used to assist this.

In both the examples in FIGS. 18 and 20, there is no additional fastener to hold the mount in place other than the friction of the pins (or other fixation means such as adhesive). However, once a module is in place with the mounting panel in position, the shelf of the module can overlap the face of the mount, retaining it in place, in a similar way to that shown in FIG. 10a.

FIG. 21 shows a further variant in which a pair of mounts are used together to define the position and orientation of the mounting panel and module. By placing the mounting panel over the mounts, it is guided into the corresponding recess on its lower surface, which as they are brought together tightly guides the mounting panel into a precise position and orientation.

FIG. 22 shows how the same mount can be positioned in a different, e.g. slightly inclined, arrangement by using a slightly different mount, in this case by positioning the hole 202 in a slightly different position. The dot-dash line shows the horizontal orientation of the holes 202. In addition to the minimised component count whilst providing flexibility in the range of shelf configurations, the unit has a number of other advantages.

As the modules are not physically notched into the uprights, this adds versatility and adaptability as noted above but also improves ease of assembly of the units. Conventional units often involve bolts. These involve drilling large holes in the uprights which can impact strength. The bolt holes would require more machining time than the smaller holes 160 which can be drilled rather than requiring pocketing. As the bolt holes are larger too, there would generally be less bolt holes meaning it would be less versatile in terms of positioning options. The present invention avoids the use of nuts and bolts on either side of the uprights and modules minimising the impact on the spacing between units, and maximising the internal space for storage.

The modules of the present invention are inserted into the unit without requiring access to the outer side of the uprights which means that the modules can be assembled into the units in situ in the vehicle since access is not required to the outer sides of the uprights, allowing the units to be pushed into position often against a bulkhead of the vehicle. This also allows retrospective modification of the shelves' layout once the units are installed whereas previous systems would have to be removed from their installation position to access bolts and nuts on the outer side. This provides extra flexibility and flexibility of later modification of the layout.

The use of the tongues on the shelves, received into the slots on the mounting panels, provides excellent strength compared to relying on bolts or other fasteners where the load is concentrated on a small part of the upright and also on the small metal components. The large tongues are integrated into the shelf itself and can transfer the often substantial loads effectively into the uprights over a greater contact area. For heavier loads, the slots can be enlarged as with slots 220b, 230b.

The wood used to form units is typically a plywood such as birch plywood or eucalyptus core plywood. Whilst this is a manufactured product, they are provided in sheets which can deform so that they do not conform to precise tolerances once machined and installed. Where these are used on larger/taller vehicles, these inconsistencies can be significant. The panels can sometimes bow or twist especially over longer runs. With the invention, having the modules in place and the ability to use additional fasteners between the module mounting panels and the uprights means that the fasteners, typically machine screws, pull the uprights in tight. This adds strength to the rack unit as a whole.

The use of the mounts with pre-installed and aligned pins makes installation extremely easy and user-friendly. They allow the installer to align the modules vertically, as well as setting their correct angle and forwards/backwards positioning. This can all be done without using any tools.

The modules can then be secured in place, as discussed above e.g. by using machine screws to secure the mounting panels to the uprights using holes 204, 224, 234 etc. and the mounts too using holes 239, where provided. This typically only requires a standard impact driver.

The pins 205 used are generally dimensioned so that the part of the main body 208a inserted into the upright is short enough to allow another pin to be inserted into the other half of the hole from the opposite side. Allowing modules to be arranged in the same position on each side of the upright which is particularly convenient, especially when using a single sheet for the upright, to avoid having to offset the shelves in adjacent units.

The larger diameter part of the hole 202 is preferably arranged to have dimensions slightly smaller than the flange 208b on the pins 205. This allows the pins to be gently hammered or pressed into the mount so that it is retained there due to friction only, avoiding the need for glue. However, the pins may be glued into the mounts, which ensures they are secured. By securing the pins in the mounts, the mounts can be installed easily without having to ensure the pins are kept in place. It also means that if and when the mounts are removed, the pins remain attached to the mount as the mounts are pulled out of the uprights. This makes later adjustments and modifications easier as the mounts are easily removed and repositioned.

Whilst the embodiments above use symmetrical pairs of mounts and mounting panels, one at each side of the module, it will be appreciated that the same benefit of the invention can be achieved with only one mount and mounting panel according to the invention at one end. The other end may have a different or simpler arrangement such as a simple horizontal slat.

In the above embodiments, the mounts are generally shown to have a portion which has a profile which closely matches the recess profile of the corresponding recess in the mounting panel. This is useful for ensuring a good engagement between the two so that the position and orientation of the mounting panel is fixed relative to the mount. However, it will be appreciated that this close match is not essential. In its crudest form, the mount could have a simple profile, such as being flat, on the upper surface and the mounting panel could have a similarly simple flat profile so that it simply sits on the mount without any control of position and orientation other than providing vertical support. This can be provided by some other element of the unit. The profiles may also be different to each other, such that there is no significant area of contact where the profiles match. For example, the mounting panel may have a rounded protrusion which sits on a flat profiled mount with a simple point contact.

Even with these simpler configurations, the portion of the mounting panel which overlaps laterally with the mount, to prevent it moving out of the panels, can still be provided. In the example above, the shelves 116, 136 overlap the mount to prevent it moving laterally so that the pins move out of the holes in the panel, so once the mounting panel is lowered onto the mount, the shelf moves downwardly adjacent to the side of the mount, trapping it laterally between the shelf side and the panel.

Although the shelves provide the retaining element in the examples above, other features of the storage module may be used, such as a simple protruding portion which extends downwardly from the bottom of the mounting panel such that the mount slides between it and the panel as the storage unit is slid into place. This could be a small tab or a much larger element that extends across the width of the mount or some or all of the depth of the storage unit, similar to the shelf. The key feature is that the sliding of the storage unit into position on the mount means a protrusion on the storage element slides down the inner side of the mount (opposite to the side adjacent to the panel) to limit movement in a direction away from the side panels and preventing the mount pins being withdrawn from the panels and the mount along with it.

1. A mounting system for a storage unit, the storage unit having a pair of laterally spaced apart upright panels separated from each other by a first distance, each upright panel having a plurality of spaced apart holes on the inner face facing the respective other upright panel, the mounting system comprising:
first and second mounts, each having one or more protruding mounting elements, each mount being removably mountable on a respective one of said upright panels by inserting said one or more protruding mounting elements into respective holes of said spaced apart holes in said upright panel, to support said mounts on the inner face of said upright panel; and
a storage module having a width substantially corresponding to the first distance, a mounting panel being provided at each side of the storage module such that the sides of the storage module are substantially adjacent to the respective upright panel when the storage module is placed between the upright panels, each mounting panel having:
a supporting portion having a lower edge arranged to rest on and be supported by the mount when the storage module is placed between the upright panels; and
a retaining element extending at least partially between the front and rear of the mounting panel and at least partially overlapping the inner lateral edge of the mount when the storage module is placed between the upright panels, such that the mount is retained between the inner face of the upright panel and the retaining clement to prevent lateral movement of the mount away from the upright panel.

2. A mounting system according to claim 1, wherein the mounting element is a securing pin projecting from the mount.

3. A mounting system according to claim 2, wherein the mount includes a plurality of pins spaced from each other at intervals corresponding to a set of said holes in the upright panel.

4. A mounting system according to claim 3, wherein the holes in said upright are arranged in a predefined pattern with different distances between respective pairs of holes and wherein said pins are spaced apart from each other by a distance corresponding to the spacing between one of said respective pairs of holes, to define a defined orientation at which the mount can be installed.

5. A mounting system according to claim 1, wherein each mount has a first portion having an upper edge with a first profile; and
each mounting panel has a second portion having an edge with a second profile corresponding to the first profile.

6. A mounting system according to claim 5, wherein said first profile of said first portion and the second profile of said second portion each have one of a corresponding generally concave and generally convex shape, such that as the mounting panel is lowered onto the mount in a first direction, the convex shaped portion is received into the concave shaped portion with the surfaces of the first and second profiles engaging each other until the mounting panel reaches an engaged position on the mount, preventing further movement in the first direction.

7. A mounting system according to claim 6, wherein the first profile and second profile are shaped such that once in the engaged position, further movement is prevented except in a direction generally opposite to the first direction, due to the engagement of the first profile and second profile.

8. A mounting system according to claim 7, wherein the first profile includes an alignment feature to guide the mounting panel into the engaged position.

9. A mounting system according to claim 8, wherein the alignment feature includes a tongue like projection having angled guiding sides.

10. A mounting system according to claim 1, wherein the mount is provided with one or more additional fastening holes for receiving a fastener to aid attachment of the mount to the upright panel.

11. A mounting system according to claim 1, wherein the mounting panel is provided with one or more additional fastening holes for receiving a fastener to aid attachment of the mounting panel to the upright panel.

12. A mounting system according to claim 1, wherein said storage module includes one or more shelves supported at one end of each shelf by said mounting panel.

13. A mounting system according to claim 1, wherein said storage module includes a plurality of shelves, at predefined spacings, supported at one end of each shelf by said mounting panel.

14. A mounting system according to claim 12, wherein said shelves are spaced independently of the spacing of the available mounting positions of the mount on the upright.

15. A mounting system according to claim 12, wherein said mounting panel includes one or more slots for receiving respective tongues projecting from said one or more shelves to support said shelves in use.

16. A kit of parts for a mounting system for a storage unit having a pair of upright panels, each having a plurality of spaced apart holes on the inner face. facing the respective other upright panel, for receiving one or more storage modules therebetween, the kit comprising:
one or more mounts, each having one or more protruding mounting elements, each mounting element insertable into one of said spaced apart holes for locating the mount on one of said upright panels and to support said mount on the inner face of said upright panel; and
a storage module having a first width, in use, the storage module having a mounting panel provided at each side of the storage module such that the sides of the storage module are substantially adjacent to the respective upright panel when the storage module is placed between the upright panels spaced apart by a first distance substantially corresponding to said first width, each mounting panel having:
a supporting portion having a lower edge which rests on and is supported by the mount when the storage module is placed between the upright panels; and
a retaining element extending at least partially between the front and rear of the mounting panel and at least partially overlapping the inner lateral edge of the mount when the storage module is placed between the upright panels, such that the mount is retained between the inner face of the upright panel and the retaining element to prevent lateral movement of the mount away from the upright panel.

17. A kit of parts according to claim 16, wherein each mounting element is a securing pin projecting from the mount.

18. A kit of parts according to claim 17, wherein the mount includes a plurality of pins spaced from each other at intervals corresponding to a set of said holes in the upright panel.

19. A method of mounting a storage module in a storage unit having: a pair of upright panels for receiving a storage module therebetween; a mount having one or more protruding mounting elements for supporting the mount on the inner face, facing the respective other upright panel, of said upright panel; and a storage module having a first width and having a mounting panel at each end, each mounting panel having:
a supporting portion having a lower edge; and
a retaining element extending at least partially between the front and rear of the mounting,
the method comprising:
arranging the upright panels a first distance apart substantially corresponding to the first width;
inserting the mounting elements of each mount into corresponding holes on said inner face of each upright panel to support said mounts on the inner face of said upright panel;
positioning said storage module between said upright panels such that the sides of the storage module are substantially adjacent to the respective upright panel;
lowering the storage module so that said lower edge of each mounting panel rests on and is supported by a respective mount and the retaining element at least partially overlaps the inner lateral edge of the respective mount to retain the mount between the inner face of the upright panel and the retaining element, to prevent lateral movement of the mount away from the upright panel.

20. A method according to claim 19, wherein each mounting element is a securing pin projecting from the mount and the method includes inserting the pin into a respective hole in said upright panel.

21. A method according to claim 20, wherein the mount includes a plurality of pins spaced from each other at intervals corresponding to a set of said holes in the upright panel and said inserting the mounting pins into said mount on said upright panel includes aligning the plurality of pins with a respective set of said holes in said upright.
